(19) United States
(12) Patent Application Publication
(10) Pub. No.: US 2017/0225966 A1
(43) Pub. Date: Aug. 10, 2017

(54) Portable Collapsible Distillation Apparatus and Methods

(71) Applicant: Robert Johnston, Green Cove Springs (FL)

(72) Inventor: Robert Johnston, Green Cove Springs (FL)

(21) Appl. No.: 14/551,189

(22) Filed: Nov. 24, 2014

Related U.S. Application Data
(60) Provisional application No. 61/907,709, filed on Nov. 22, 2013.

(51) Int. Cl. C02F 1/18; B01D 3/02; C02F 1/14

(52) U.S. Cl. CPC C02F 1/18; C02F 1/14; B01D 3/02; C02F 2103/08

(57) ABSTRACT

A portable, collapsible still includes an upper reservoir for coolant water, an intermediate condensing chamber, and a lower reservoir of an aqueous solution, for example, seawater. A condenser coil is in fluid communication with the headspace in the lower reservoir above its fluid level, with the coil extending into the condenser chamber and to an external fluid port. A reflector is positioned below the lower reservoir, to reflect sunlight onto the lower reservoir to heat it. As the water vapor pressure in the lower reservoir increases as a result of the solar heating, the water vapor enters the coil, which is bathed in the lower temperature coolant water from the upper reservoir, causing the water vapor to condense inside the coil and thus be available for drinking.

This application claims priority to U.S. Provisional App. No. 61/907,709, filed 22 Nov. 2013, by Robert Johnston, the entirety of which is incorporated by reference herein.

### BACKGROUND

Field of Endeavor

The present invention relates to devices, systems, and processes useful for water distillation, and more specifically to portable, collapsible water stills.

Brief Description of the Related Art

Ocean voyagers are always wary of the risk of running out of potable water. Tankage on cruising boats is often inadequate for long passages, and water stored in portable tanks (e.g., ‘Jerry Jugs’) is at risk of spoiling. While there is plenty of ocean water, it is not drinkable.

Many boats are equipped with water makers using reverse osmosis (RO) to separate the salts from the water. However, these require large amounts of electrical power, which, at times, may not be available (an electrical charger breakdown, battery failure, engine failure).

In addition, there is always the unlikely event of the main vessel sinking, and being left in a life raft with a very meager supply, if any, of fresh water. Again, hand powered RO watermakers are available, but are expensive, and may not be readily available when the ship goes down.

Similarly, many cross-country hikers, back-packers, and those traveling by automobile or horseback through arid country (e.g., Nevada), may need a convenient, portable system for making fresh water from meager, often contaminated or saline water. Water filters are commonly commercially available, which can remove bacteria from contaminated water, but cannot remove viruses, many chemicals, and salts.

Much of recreational ocean cruising is carried out in warm climates with ample sunshine (often too much!). It is reasonable then, to consider using that power to create fresh water from salt water through distillation.

### SUMMARY

According to a first aspect of the invention, a low cost, portable, collapsible, rust free, light weight distillation apparatus is capable of generating small but adequate quantities of fresh water relying only on solar power. The product may be made to be self-supporting (free standing) or (more simply, and lighter) to be hanged from a makeshift stand or other elevated object (the boom on a boat, the rigging, a tree branch, or a tripod of sticks or oars, etc.). It is best used where there is no, or very limited, shade, as direct sunlight will be far more effective than ambient heat to produce the desired outcome. It is designed to be collapsed to fit into a fabric container 12″ in diameter and no more than 3″ high; it weighs no more than 2 pounds.

Still other aspects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to exemplary embodiments of the apparatus and method, given only by way of example, and with reference to the accompanying drawings, in which:

FIG. 1 illustrates a side elevational view of an exemplary distillation device;

FIG. 2 illustrates a top plan view of the device of FIG. 1;

FIG. 3 illustrates a side elevational view of another exemplary distillation device; and

FIG. 4 illustrates a top plan view of the device of FIG. 3.

### DETAILED DESCRIPTION OF EXEMPLARY EMBODIMENTS

Referring to the drawing figures, like reference numerals designate identical or corresponding elements throughout the several figures.

The singular forms “a,” “an,” and “the” include plural referents unless the context clearly dictates otherwise. Thus, for example, reference to “a solvent” includes reference to one or more of such solvents, and reference to “the dispersant” includes reference to one or more of such dispersants.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited.

For example, a range of 1 to 5 should be interpreted to include not only the explicitly recited limits of 1 and 5, but also to include individual values such as 2, 2.7, 3.6, 4.2, and sub-ranges such as 1-2.5, 1.8-3.2, 2.6-4.9, etc. This interpretation should apply regardless of the breadth of the range or the characteristic being described, and also applies to open-ended ranges reciting only one end point, such as “greater than 25,” or “less than 10.”

Exemplary embodiments of portable, collapsible, distillation apparatus can have a number of features including, but not limited to:

Portability, using light weight, plastic components

Fit into fabric a container of, e.g., 12″ diameter, 2″ thick

Weight less than 2 lbs.

Collapsible, all rigid members fold or disassemble

All rigid members less than 1 foot long

Principle containers are formed of heavy duty polyethylene (or equivalent)

Rust free, having no metallic fixtures/joints/fasteners, or formed of non-corrosive materials, such as aluminum, titanium, stainless steel, and the like

Distillation purpose: to provide emergency device or creating fresh water (potable) from salt or contaminated water using the sun as only energy source.

Benefits include that no external fuels are required

No complex, heavy machinery required (e.g., reverse osmosis water maker)

Low cost

Design Considerations

One goal is to produce a portable (lightweight, small), collapsible (to reduce volume), rust free (due to intentional presence of water fresh and salt), effective system for making potable water from that which is available in situations of distress in which no fresh water is at hand.

An exemplary unit can be packed into a fabric container 12″ in diameter and not more than 3″ in height. These parameters are somewhat arbitrary and not an essential quality of the system. Size may be varied in order to improve portability, tune the production to the need, or other considerations (e.g., materials costs). An additional objective is affordability, as current RO hand-operated units cost upward of $400.00. Commonly commercially available filters are less expensive, but have only limited applicability, as discussed above.

The system capitalizes on the fact that sunlight (and especially the infra-red end of the spectrum) is differentially absorbed by materials of different color. The device includes two reservoirs, for the coolant (e.g., fresh, cool sea water, which can also be water yet to be distilled, that is, source water), and for the source water (e.g., sea water, stream water, stagnant water), with a condensing chamber between then, where the coolant from the coolant reservoir surrounds a coiled, thermally conductive conduit for the vapor from the source reservoir. The coolant reservoir is surrounded by a reflective surfaced, flexible plastic wall (to reduce heat absorption) and the source water reservoir is surrounded by a black flexible plastic wall (to enhance absorption of infrared and other solar energy). In addition, the whole unit is topped by a reflective (e.g., aluminized) shade, additionally reducing energy input to the coolant reservoir; and the unit rests upon or within a reflective curved plastic power collector, designed to amplify the amount of light energy reaching the source water reservoir.

It is expected that by using water drawn from at least five (5) feet under the surface of the water (in tropical zones) in the coolant reservoir (75 degrees Fahrenheit), and by using surface water in the source water reservoir (80 to 85 degrees Fahrenheit), during the daytime, a temperature differential of at least 60 degrees Fahrenheit may be achieved (approximately 140 degrees Fahrenheit in the exposed source water reservoir). While this will not boil the water, it will substantially increase the vaporization rate.

The vapor from the source water reservoir will ascend into a coiled tube within the condensing chamber, where it is surrounded by coolant (optionally flowing at a controlled rate suited to the need and availability from the above coolant chamber). The output of that condensing tube will flow to a suitable potable water container. The output of the condensing chamber (used coolant) will in turn be moved to the evaporation reservoir, thus preserving heat absorbed from the condensation process.

Turning now to the drawing figures, specific design features will be discussed with reference thereto. The unit 10 is topped by an eye or hanger 20 suitable to support the unit, including the water in the filled unit. Surrounding and radiating from the eye 20 are a plurality, e.g., eight, equally spaced support units or braces 24 securing an upper ring 26 of an upper, coolant reservoir 12 to the eye, and extending beyond the ring to provide support to an overhanging shade 16.

The shade 16, which is advantageously reflective, fits loosely over the frame formed by the braces 24, with spacing between it and the underlying coolant reservoir 12 to allow adequate air flow. The shade 16 preferably includes at least one, e.g., four, apertures 22 near the apex of the shade to allow for thermal convection of air beneath the shade.

From the upper ring 26 of the coolant reservoir 12 will hang the remaining components, advantageously in a cylindrical form, requiring only sufficient material strength in the walls to support the weight of the water contents and the unit. For rigidity of form, the bottom of the coolant reservoir 12 and the top and bottom of the lower, source water reservoir 14 will also be formed around a rigid (plastic) ring (not illustrated). The upper 12 and lower 14 reservoirs each have an aperture, near the top and another near the bottom in the side walls of each, suitable for connecting an external fill tube and an external drain tube, as needed, for the purpose of filling and emptying the reservoirs. These external tubes (not illustrated) are also advantageously fitted with valves to control the flow of fluid through the apertures and tubes.

The upper (coolant) reservoir 12 has a drain port 48 near its bottom, and a small (e.g., approximately ½″) aperture 50 in its floor directly connecting it to a condensing chamber 30. The condensing chamber 30 is formed by the taught, flat bottom of the coolant reservoir 12 on top, and the upward tented top 32 of the underlying source water reservoir 14, and is secured to the bottom of the upper reservoir centrally. A fitting suitable to provide vapor escape from the evaporating (source water) chamber 14 into a thin walled (preferably) clear plastic tube 34 (see FIG. 2), which acts as a condenser coil, is on or near the apex of the condensing chamber floor 32. The clear plastic (condensing) tube 34 spirals or otherwise follows a complex path around the center of the top 32, proceeding outward from the inlet fitting from the headspace above the water in the lower, source reservoir, until it joins the side wall fitting 34 suitable for connecting a fresh water output hose or tube. The purpose is thus to provide heat exchange to condense vapor from the reservoir and preheat water for later evaporation.

The side wall of the condensing chamber 30 includes a fitting 36 near the top suitable for an adjustable valve to allow control of discharge of warmed coolant from the condensing chamber.

The source water reservoir 14 has a top 32 which is tented or otherwise forms a sloped surface, from a generally central apex down to lower peripheral edges, and is fenestrated, as previously described. The reservoir 14 includes a fill port 38 and a drain port 40 in the side wall as described above.

Beneath the lower reservoir 14, an up-curved (upside-down-umbrella shaped), preferably octagonal, reflective sheet 42 is positioned, and is designed to increase the energy delivery from the sun to the lower reservoir. The sheet 42 is reflective on the inside or top surface 44, and held in place by removable, flexible plastic ribs 46 (FIG. 2) which secure to the bottom ring of the source water reservoir 14 and into pockets at the rim of the sheet. The ribs produce enough tension to hold the assembly in place with the unit hanging from the eye 20.

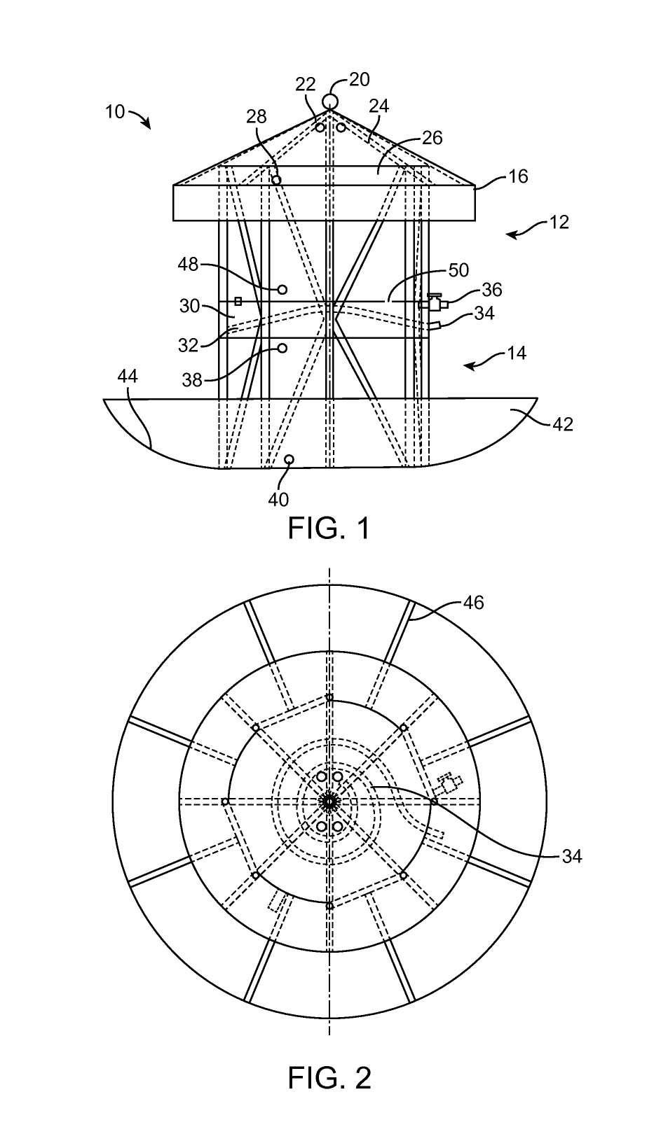

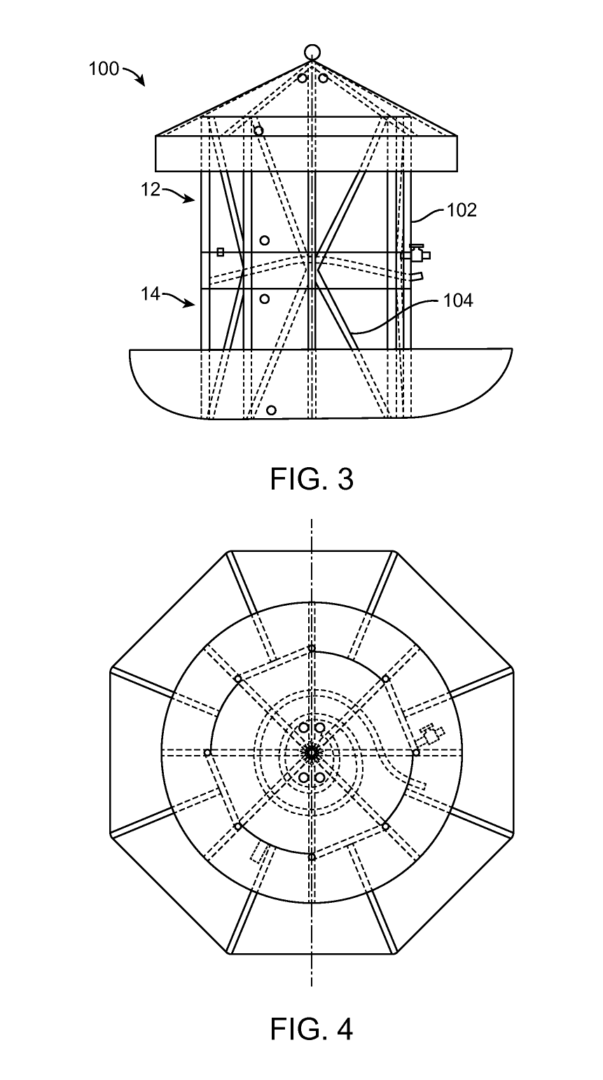

According to another exemplary embodiment, illustrated in FIGS. 3 and 4, a free standing unit 100 includes the structures as described above with reference to FIGS. 1 and 2, with the exceptions which follow. The unit 100 includes a plurality of, e.g., eight, folding, locking vertical members 102 connecting the upper ring of the coolant reservoir 12 with the bottom ring of the source water reservoir 14. A plurality of, e.g., four, folding angle braces 104 are positioned so as to alternate in the direction of the angled portions to provide lateral stability of the unit. Additional bracing units may be used as needed, depending on size, stability, lateral stresses encountered.

In addition to the foregoing, additional components can optionally be included in a system as described herein. All fluid ports should be suitable for attachment of ⅜″ I.D. clear plastic tubing suitable for drinking water. A small hand pump can be provided, suitable to lift water at least six (6) feet and pump it with limited resistance another three (3) feet up, and moving about four (4) fluid ounces per stroke, with input and output connectors suited to the ⅜″ I.D. tubing above. The hand pump can be particularly useful when using a system as described herein on a boat, particularly a sailboat, as the pump permits a single user to pump seawater from below the waterline of the vessel and into the coolant reservoir 12, to replenish the coolant as it is heated from heat exchange with the condensing water vapor from the source water reservoir in the condensing coil. For such uses, a 10 foot length of ⅜″ I.D. (clear) plastic tubing for coolant water (a sufficient length to get at least five feet beneath the surface of the water) is also provided and attached to the pump inlet. A six (6) foot length of ⅜″ I.D. clear plastic tubing is provided for source water, and condenser coolant output. A three (3) foot length of ⅜″ I.D. clear plastic tubing is provided for the pump output to reservoir inlet. A two (2) foot length of ⅜″ I.D. clear plastic tubing is provided for the condenser (fresh water) output. Advantageously, a fabric container is suitable for all components. The overall design is such that the forces of gravity and the shaping of the flexible structural material provide the unit with dimensional stability. The spring/elasticity in the braces 46, along with the fabric shaping, provide the necessary dimensional stability of the reflective sheet, much as the spring metal and material form an umbrella. The fluid reservoirs are advantageously made of a collapsible, water impervious material.

In operation, the upper reservoir 12 is filled, at least partially, with a liquid coolant, which is easily achieved with sea-, lake-, or stream-water, and the lower reservoir 14 is at least partially filled with source water, e.g., sea-, lake-, or stream-water, which is not (yet) potable. The unit is placed in the sun, so that sunlight is reflected off of the inner, reflective, curved surface 44 of the sheet 42, and onto the exterior wall of the lower reservoir 14. The liquid coolant from the reservoir 12 is permitted to flow from the reservoir 12 into the condensing chamber 30, via the opening 50 between them, and thus at least partially, and preferably completely, covers the exterior surface of the condensing coil 34. Optionally, the opening 50 is closed by a valve which is can be opened and closed by the user. As the source water in the lower reservoir 14 is heated by the intensified sunlight from the reflector sheet 42, the coolant (water) from the upper reservoir remains essentially the same temperature, in part because of the reflective outer surface of the outer reservoir 12 and the shade 16. Water vapor is generated at increasing rates in the lower reservoir because of the increased heat transfer to the water in the lower reservoir, and the water vapor rises up through the fitting in the apex of the top of the lower reservoir and into the condensing coil 34. The condensing coil 34 is at a lower temperature than the water vapor from the source reservoir, and thus liquid water condenses on the inner surface of the tube forming the coil. Because the uppermost portion of the condensing coil 34 is positioned at its connection to the reservoir 14, the resultant condensate water is free to flow down the coil and away from the reservoir 14, towards the fresh water outlet 34. As the heat transfer between the condenser coil 34 and the coolant (water) surrounding it, from the energy released from condensing the water vapor, increases the temperature of the coolant, the coolant can be bled off at the coolant outlet 36, with new, cooler coolant flowing into the condenser chamber from the reservoir 12, and the warmed, used coolant transferred to the lower reservoir for later distillation. For thus purpose, the condensing chamber can be in fluid communication, e.g., via a tube (not illustrated), optionally fitted with a valve, with the source reservoir.

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

I claim:

1. A portable still comprising:
an upper reservoir;
a lower reservoir having an upper wall, an outer wall, and a fluid port in the upper wall;
a condensing chamber positioned between the upper reservoir and the lower reservoir, the condensing chamber being in fluid communication with the upper reservoir;
a condenser tube positioned in the condensing chamber and being fluidly connected to the fluid port in the lower reservoir upper wall; and
a reflector positioned adjacent to the lower reservoir, the reflector shaped to reflect sunlight from the reflector onto the lower reservoir outer wall.

2. A portable still according to claim 1, wherein the lower reservoir upper wall comprises an apex, and the fluid port is positioned at the apex.

3. A portable still according to claim 1, further comprising:
a shade positioned outside and above at least a portion of the upper reservoir.

4. A portable still according to claim 1, wherein the upper reservoir has an outer reflective surface.

5. A portable still according to claim 1, wherein the lower reservoir has a black outer surface.

6. A portable still according to claim 1, wherein the condenser chamber includes an outer wall, and further comprising:
a fluid port in the condenser chamber outer wall;
wherein the condenser tube is fluidly connected to the condenser chamber fluid port.

7. A portable still according to claim 7, wherein the condenser tube is coiled between the lower reservoir fluid port and the condenser chamber fluid port.

8. A portable still according to claim 1, wherein at least one of the upper reservoir, the condensing chamber, and the lower reservoir is formed of a collapsible material.

9. A portable still according to claim 1, further comprising:
braces attached to the exterior of the upper reservoir, the condenser chamber, the lower chamber, or combinations thereof.

10. A method of producing potable water, the method comprising:
providing a still according to claim 1;
at least partially filling the upper reservoir with a coolant, such that coolant flows into the condensing chamber and at least partially covers the exterior of the condensing tube;
at least partially filling the lower reservoir with an aqueous solution; and
exposing an inner surface of the reflector to sunlight for a time sufficient to generate water vapor in the lower reservoir of sufficient quantity to flow into the condenser tube and condense on an inner surface thereof, wherein vapor within the condensing tube preheats the coolant for subsequent distillation from the lower reservoir.

11. A method according to claim 10, further comprising:
draining at least a portion of the coolant from the condensing chamber and simultaneously adding coolant from the upper reservoir to the condensing chamber.

12. A method according to claim 11, wherein:
vapor within the condensing tube preheats the coolant for subsequent distillation from the lower reservoir; and
draining at least a portion of the coolant comprises transferring coolant to the lower reservoir.
